(19) United States
(12) Patent Application Publication
(10) Pub. No.: US 2015/0268718 A1
(43) Pub. Date: Sep. 24, 2015

(54) ELECTRONIC APPARATUS AND ITS CONTROL METHOD

(71) Applicant: Kabushiki Kaisha Toshiba, Tokyo (JP)

(72) Inventor: Noriyo Fujii, Ome (JP)

(21) Appl. No.: 14/481,495

(22) Filed: Sep. 9, 2014

(30) Foreign Application Priority Data
Mar. 18, 2014 (US) JP 2014-055667

(51) Int. Cl. G06F 3/01

(52) U.S. Cl. CPC G06F 3/011; G06F 3/015

(57) ABSTRACT

One embodiment provides a wearable electronic apparatus including a non-contact sensor, a judgment section and a controller. The judgment section judges whether the electronic apparatus is in a worn/carried state or in a non-worn/carried state on the basis of a detection value of the non-contact sensor. The controller which sets an operation mode of the electronic apparatus into a first mode or a second mode based on a judgment result of the judgment section. If the judgment section judges that the electronic apparatus is in the worn/carried state, the operation mode is set into the first mode. If the judgment section judges that the electronic apparatus is in the non-worn/carried state, the operation mode is set into the second mode.

### CROSS-REFERENCE TO RELATED APPLICATION(S)

This application claims priority from Japanese Patent Application No. 2014-055667 filed on Mar. 18, 2014, the entire contents of which are incorporated herein by reference.

### FIELD

Embodiments described herein relate generally to an electronic apparatus and its control method.

### BACKGROUND

In recent years, small information apparatus (watch-type wearable terminals etc.) incorporating various sensors and a wireless communication function have been put on the market. Being high in convenience, such small information apparatus are desired to usable for a long time.

Among such small information apparatus are ones which enable long-time use by automatically stopping the operation of all or part of the system by judging whether the apparatus is worn or not. Although wearing detection is commonly done using a pulse wave sensor, an event may occur that no pulse wave is detected (erroneous detection) due to, for example, an inappropriate manner of wearing of the apparatus.

Whereas techniques of using plural sensors that detect contact (contact sensors such as a pressure sensor and an open/close sensor utilizing magnetism, for example), no techniques that also use a non-contact sensor(s) have been disclosed yet. Although techniques are known that use a direction sensor or some other sensor to detect a wearing state, no specific detection methods are disclosed in this connection.

### BRIEF DESCRIPTION OF DRAWINGS

A general architecture that implements the various features of the present invention will now be described with reference to the drawings. The drawings and the associated descriptions are provided to illustrate embodiments and not to limit the scope of the present invention.

FIG. 1 is a perspective view showing an appearance of a wearable terminal according to an embodiment of the present invention.

FIG. 2 is a block diagram showing the system configuration of the wearable terminal according to the embodiment.

FIG. 3 is a block diagram showing functional blocks relating to a pulse wave sensor of the wearable terminal according to the embodiment.

FIG. 4 is a block diagram showing functional blocks of the overall wearable terminal according to the embodiment.

FIGS. 5A and 5B show how erroneous detection occurs due to a common erroneous operation that may occur in pulse wave sensors as used in the embodiment.

FIG. 6 is a flowchart of a wearing detection method according to the embodiment.

FIG. 7 shows relationships between use states, assumed by the user, of the wearable terminal according to the embodiment and expected detection results of sensors.

FIG. 8 shows how in a conventional system a detected state variation influences the system.

### DETAILED DESCRIPTION

One embodiment provides a wearable electronic apparatus including a non-contact sensor, a judgment section and a controller. The judgment section judges whether the electronic apparatus is in a worn/carried state or in a non-worn/carried state on the basis of a detection value of the non-contact sensor. The controller which sets an operation mode of the electronic apparatus into a first mode or a second mode based on a judgment result of the judgment section. If the judgment section judges that the electronic apparatus is in the worn/carried state, the operation mode is set into the first mode. If the judgment section judges that the electronic apparatus is in the non-worn/carried state, the operation mode is set into the second mode.

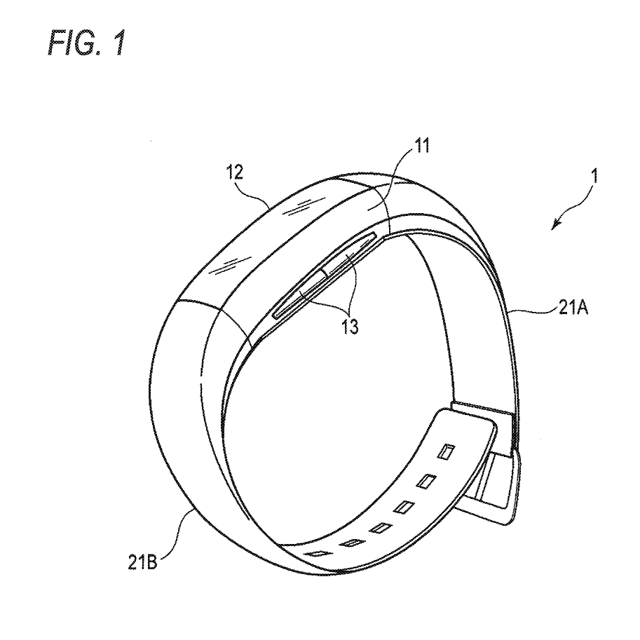

An embodiment of the present invention will be hereinafter described with reference to FIGS. 1-8. An electronic apparatus according to the embodiment is of such a type as to be worn by a human body (what is called a wearable terminal). The embodiment assumes that the electronic apparatus is implemented as a watch-type wearable terminal which is typically used being worn on an arm (wrist) of a user.

FIG. 1 is a perspective view of a wearable terminal 1. The wearable terminal 1 has a main body 11 which is a thin body. Various electronic components are provided in the main body 11. The top surface of the main body 11 is provided with a display 12 such as a liquid crystal display device (LCD). The display 12 may be a touch screen display capable of detecting a contact position on its display screen. Manipulation buttons 13 are disposed on a side surface of the main body 11.

The wearable terminal 1 is equipped with belts (bands) 21A and 21B for attaching the main body 11 to a human body (arm). Each of the belts 21A and 21B is a flexible member.

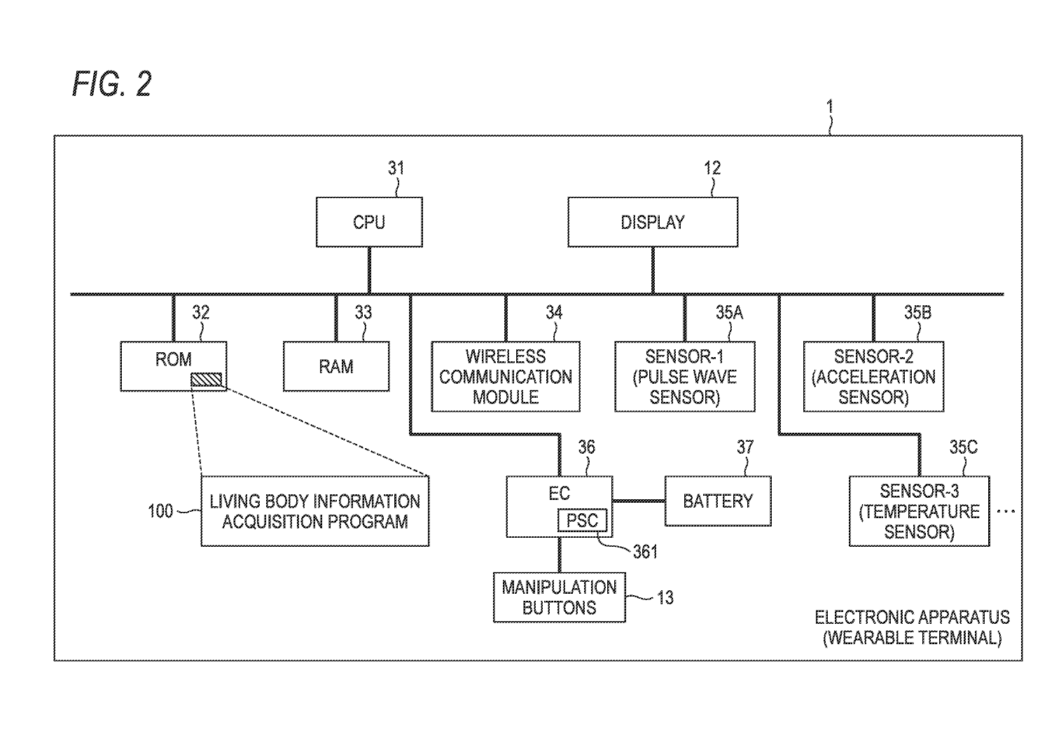

FIG. 2 is a block diagram showing the system configuration of the wearable terminal 1. Disposed in the main body 11 of the wearable terminal 1 are the display 12 and the manipulation buttons 13 shown in FIG. 1, components shown in FIG. 2 which are a CPU 31, a ROM 32, a RAM 33, a wireless communication module 34, plural sensors 35A, 35B, 35C, . . . , an EC (embedded controller) 36, and a battery 37, and other components.

The CPU 31 is a processor which controls the operations of various modules provided in the wearable terminal 1. The CPU 31 runs various programs stored in the ROM 32 while using the RAM 33 as a work area. One of the various programs is a living body information acquisition program 100 (described later).

The wireless communication module 34 is a module for performing a wireless communication according to the IEEE 802.11g, for example. The plural sensors 35A, 35B, 35C, . . . are a pulse wave sensor, an acceleration sensor, a temperature sensor, an angular velocity sensor, a geomagnetic sensor, a humidity sensor, an illuminance sensor, and a pressure sensor, etc. It is assumed here that the sensors 35A, 35B, and 35C are a pulse wave sensor, an acceleration sensor, and a temperature sensor, respectively. The temperature sensor 35C may be one having a deep body thermometer function of detecting living body data (body temperature data) relating to a user body temperature. Detection values of the respective sensors are stored in the RAM 33 and will be used by various programs including the living body information acquisition program 100.

The EC 36 is a one-chip microcomputer including a PSC (power supply controller) 361 which controls the supply of power to the various modules of the wearable terminal 1 from a battery 37. The EC 36 has a function of receiving an instruction made by the user by manipulating the manipulation buttons 13.

The living body information acquisition program 100 is a program for acquiring living body information such as a pulse and an activation state of the autonomic nerves of the user who wear the wearable terminal 1 using the pulse wave sensor 35A, for example. The pulse wave sensor 35A, which is, for example, a reflective photoelectric sensor, measures the intensity of a blood flow by emitting light toward a blood vessel and receiving reflection light from it utilizing a phenomenon that hemoglobin in blood absorbs light. If it is a transmissive photoelectric sensor, the pulse wave sensor 35A receives light that has passed through a blood vessel. In either case, when a blood flow is strong, hemoglobin light absorbance is higher and hence the amount of received reflection light or transmission light is smaller than in the case of a weak blood flow.

The power consumption of the pulse wave sensor 35A which measures a pulse wave by emitting light accounts for not a small part of the total power consumption of the wearable terminal 1. In view of this, the wearable terminal 1 according to the embodiment is provided with a mechanism of reducing the power consumption properly in accordance with a situation by controlling the light emission power of the pulse wave sensor 35A adaptively. This feature will be described below.

While worn by the user, the wearable terminal 1 may operate under an environment with large body movements or strong ambient light (in the case of an illuminance sensor, for example). A body movement and ambient light each cause noise in the pulse wave sensor 35A which is a photoelectric sensor. On the other hand, the wearable terminal 1 may also operate under an environment with small body movements or weak ambient light. In view of the above, in the wearable terminal 1 according to the embodiment, when the influences of body movements and ambient light are large, the light emission power of the pulse wave sensor 35A is set relatively high to make the S/R ratio larger than a standard level. When the influences of body movements and ambient light are small, the light emission power of the pulse wave sensor 35A is set low (within such a range that the S/R ratio can be kept larger than the standard level) to reduce the power consumption of the pulse wave sensor 35A.

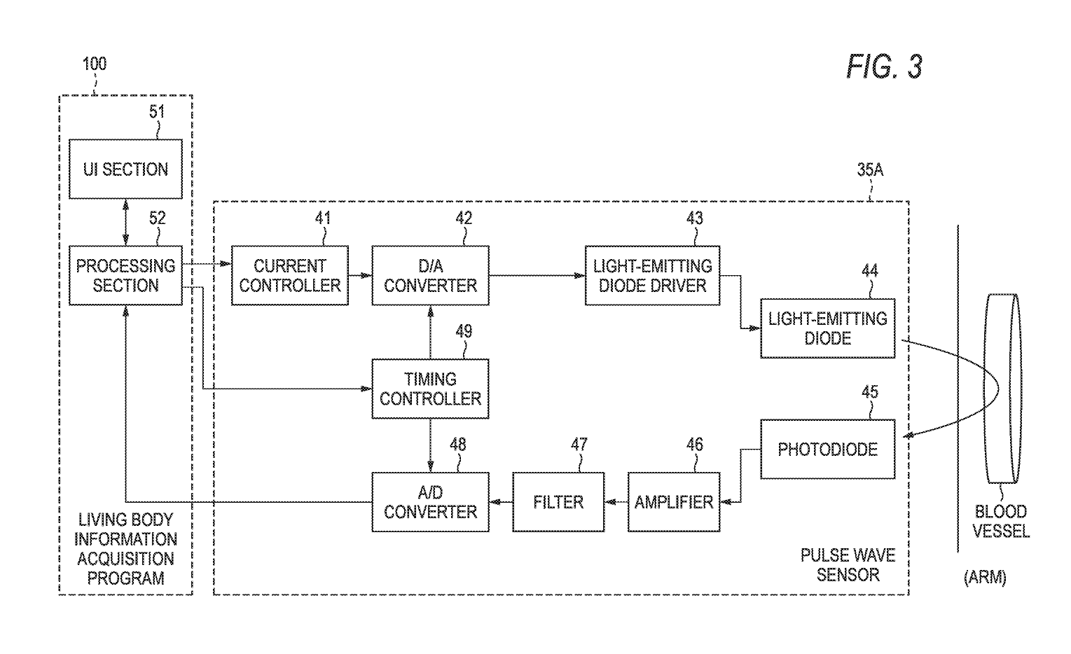

FIG. 3 is a block diagrams showing functional blocks relating to the pulse wave sensor 35A of the wearable terminal 1. As shown in FIG. 3, the pulse wave sensor 35A is equipped with a current controller 41, a D/A converter 42, a light-emitting diode driver 43, a light-emitting diode 44, a photodiode 45, an amplifier 46, a filter 47, an A/D converter 48, and a timing controller 49.

The light-emitting diode 44 and the photodiode 45 are disposed in the back surface of the main body 11 which is placed close to the skin of the user who wears the wearable terminal 1. The pulse wave sensor 35A emits light toward a blood vessel that is located close to the skin with the light-emitting diode 44 and receives resulting reflection light with the photodiode 45. The light-emitting diode driver 43 drives the light-emitting diode 44 according to a drive signal that is supplied from the D/A converter 42. Therefore, the light emission power of the light-emitting diode 44 can be controlled by controlling the value of the drive signal through the D/A converter 42. Thus, the light emission power of the light-emitting diode 44 is controlled by setting a current value using the current controller 41 and/or setting a duty ratio using the timing controller 49.

Data indicating a reception light quantity of reflection light is output from the photodiode 45 and amplified by the amplifier 46. The amplified data is supplied to the A/D converter 48 via the filter 47, and data (pulse wave data) is output from the A/D converter 48 with timing that corresponds to light emission timing of the light-emitting diode 44.

The living body information acquisition program 100 has a user interface (UI) section 51 and a processing section 52. The processing section 52 judges a state of the user who wears the wearable terminal 1 on the basis of the pulse wave data that is output from the A/D converter 48 of the pulse wave sensor 35A.

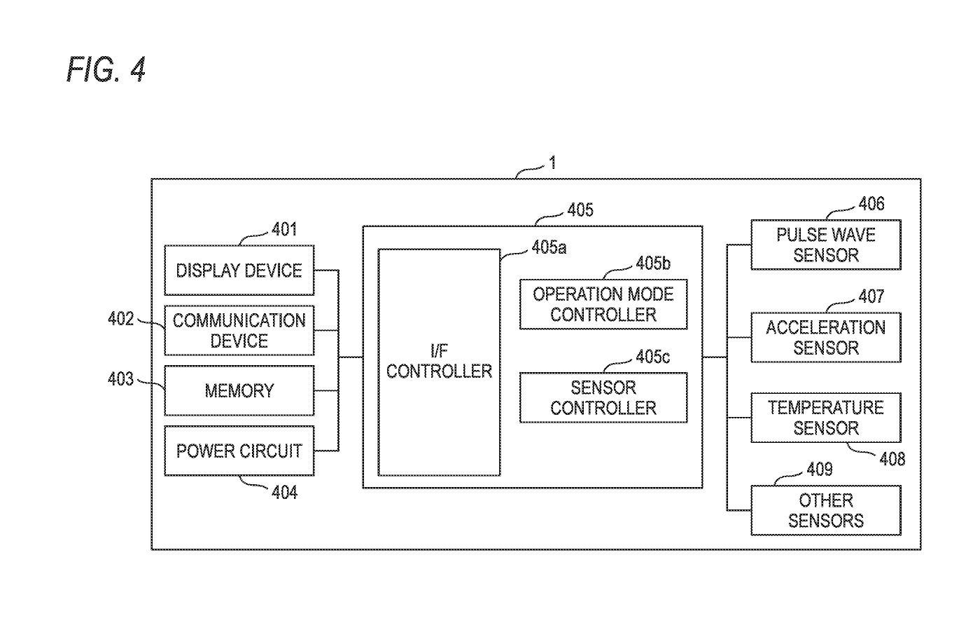

FIG. 4 is a block diagram showing internal processing function blocks of the wearable terminal 1 shown in FIGS. 1-3. As shown in FIG. 4, the internal processing function blocks are a display device 401, a communication device 402, a memory 403, a power circuit 404, a controller 405, a pulse wave sensor 406, an acceleration sensor 407, a temperature sensor 408, and other sensors (pressure sensor etc.) 409.

The controller 405 includes control subunits which are an I/F controller 405a, an operation mode controller 405b, a sensor controller 405c. It is assumed that the display unit 401, which operates under the control of the I/F controller 405a like the communication device 402, the memory 403, and the power circuit 404, is the display 12 described above with reference to FIGS. 1 and 2, and that the other blocks are included in the main body 11 of the wearable terminal 1. It is noted that one function of the manipulation units 13 is to allow the user to turn on and off the power circuit 404 by manipulating them directly.

The communication device 402 is implemented as the wireless communication module 34, the memory 403 corresponds to the ROM 32 and the RAM 33, and the power circuit 404 is mainly composed of the battery 37. The controller 405 is functions of the CPU 31. The pulse wave sensor 406, the acceleration sensor 407, the temperature sensor 408, which operate under the control of the sensor controller 405c, are implemented as the pulse wave sensor 35A, the acceleration sensor 35B, and the temperature sensor 35C, respectively.

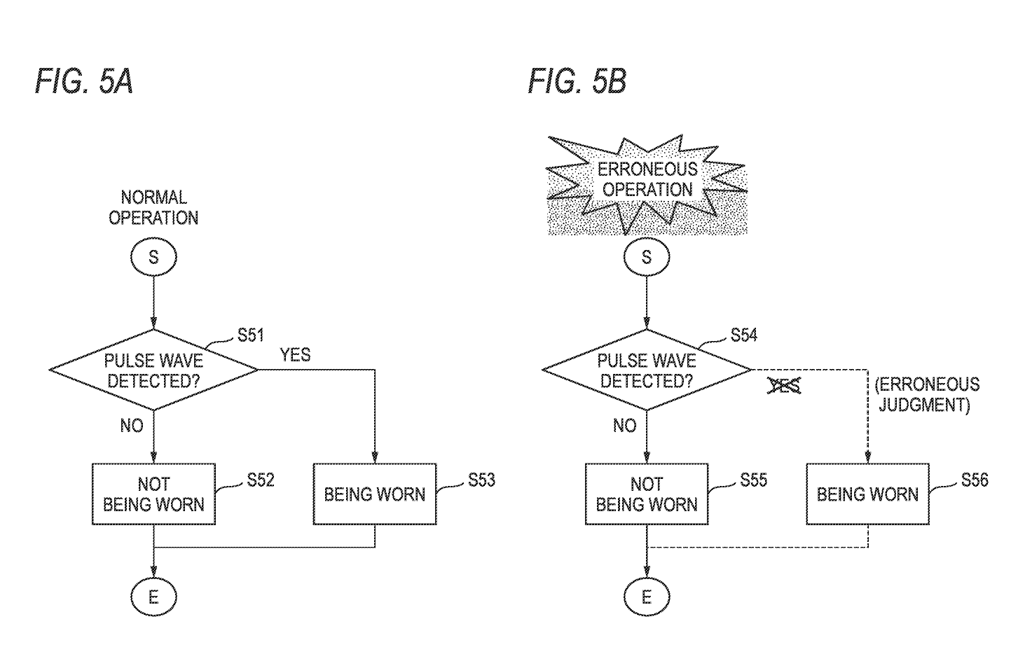

Next, how the individual functional blocks shown in FIG. 4 operate will be described with reference to FIGS. 5A and 5B to FIG. 8. First, FIGS. 5A and 5B show how erroneous detection occurs due to a common erroneous operation that may occur in pulse wave sensors as used in the embodiment.

In general, when a user actually wears such an apparatus as the wearable terminal 1, as shown in FIG. 5A entitled “normal operation,” the apparatus can correctly detect that it is worn (step S53) or not worn (step S52) as long as the pulse wave sensor is operating normally (judged at step S51). However, if the pulse wave sensor operates erroneously due to, for example, a contact failure (at a judgment step S54), as shown in FIG. 5B, the apparatus cannot detect that it is worn and erroneously judges that it is not worn (step S55). This type of erroneous detection may occur when a contact sensor is used. Erroneous detection of a state that the apparatus is not worn is rare (step S55).

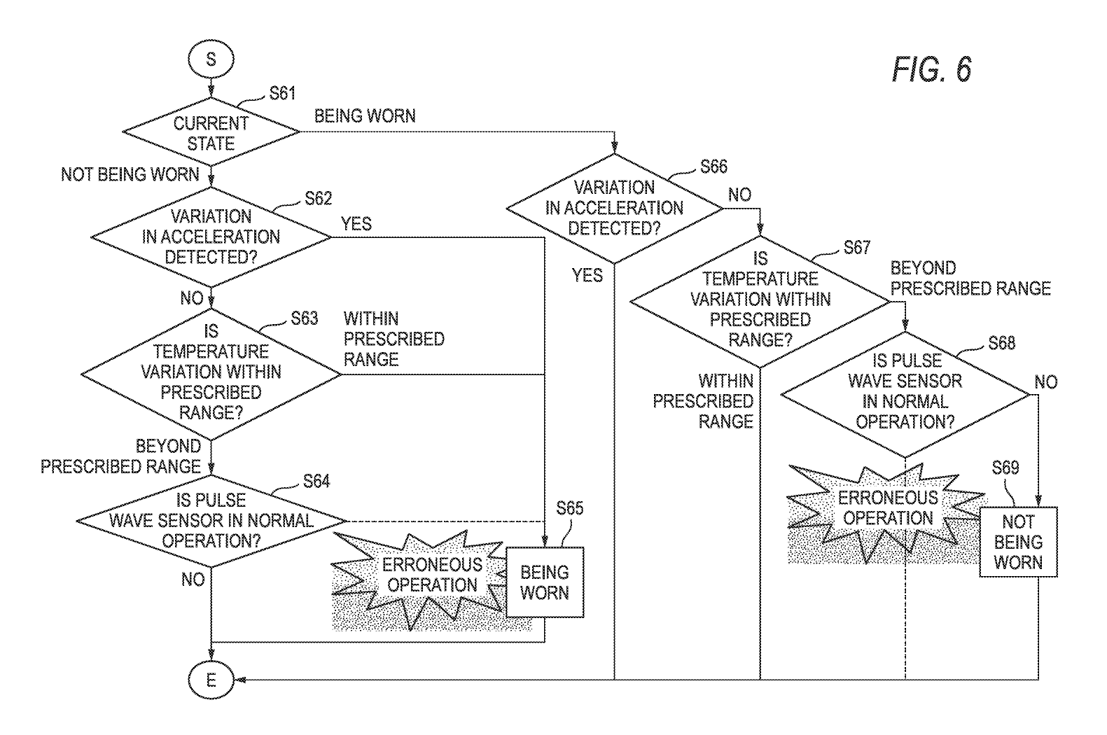

In contrast, as shown in FIG. 6, additional use of the acceleration sensor 407 and the temperature sensor 408 produce new wearing detection routes. FIG. 6 is a flowchart of a wearing detection method according to the embodiment. In outline, in any of the following cases, a judgment “worn (or being put on)” is made and hence an event can be prevented that an erroneous judgment “not worn” is made though the wearable terminal 1 is worn. For details, refer to individual steps to be described later.

### <Wearable Terminal 1 Not Worn Currently>

The controller 405 checks whether or not the acceleration sensor 407 has detected a variation, and judges that the wearable terminal 1 is worn if the acceleration sensor 407 has detected a variation.

The controller 405 checks a body temperature variation detected by the temperature sensor 408, and judges that the wearable terminal 1 is worn if the variation is within a prescribed range.

### <Wearable Terminal 1 Worn Currently>

The controller 405 checks whether or not the acceleration sensor 407 has detected a variation, and judges that the wearable terminal 1 is worn if the acceleration sensor 407 has detected a variation.

The controller 405 checks a body temperature variation detected by the temperature sensor 408, and judges that the wearable terminal 1 is worn if the variation is within the prescribed range.

Step S61: The controller 405 checks a current state. The controller 405 moves to step S62 if the wearable terminal 1 is not worn, and to step S66 if it is worn. Settings may be made so that if a current state is not determined, a worn state or a non-worn state is assumed and the controller 405 moves to a step corresponding to the assumed state.

Step S62: The controller 405 checks whether or not the acceleration sensor 407 has detected a variation. The controller 405 moves to step S65 if the acceleration sensor 407 has detected a variation, and to step S63 if the acceleration sensor 407 has detected no variation.

Step S63: The controller 405 checks a body temperature variation detected by the temperature sensor 408. The controller 405 moves to step S65 if the variation is within a prescribed range, and to step S64 if the variation is out of the prescribed range.

Step S64: The controller 405 checks whether or not the pulse wave sensor 406 is operating normally. The controller 405 moves to step S65 if the pulse wave sensor 406 is operating normally. If not, the controller 405 finishes the process while maintaining the current judgment “not worn.”

Step S65: The controller 405 judges that the wearable terminal 1 is worn. Then the controller 405 finishes the process.

Step S66: The controller 405 checks whether or not the acceleration sensor 407 has detected a variation. If the acceleration sensor 407 has detected a variation, the controller 405 finishes the process while maintaining the current judgment “worn.” The controller 405 moves to step S67 if the acceleration sensor 407 has detected no variation.

Step S67: The controller 405 checks a body temperature variation detected by the temperature sensor 408. If the variation is within the prescribed range, the controller 405 finishes the process while maintaining the current judgment “worn.” The controller 405 moves to step S68 if the variation is out of the prescribed range.

Step S68: The controller 405 checks whether or not the pulse wave sensor 406 is operating normally. If the pulse wave sensor 406 is operating normally, the controller 405 finishes the process while maintaining the current judgment “worn.” If not, the controller 405 moves to step S69.

Step S69: The controller 405 judges that the wearable terminal 1 is not worn. Then the controller 405 finishes the process.

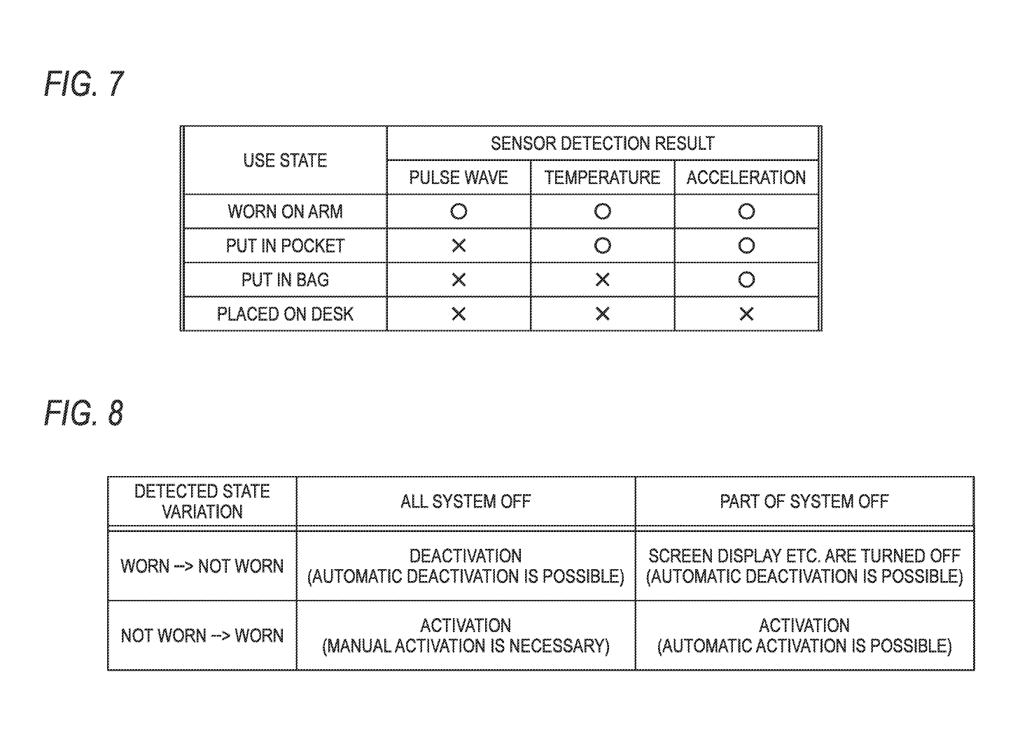

FIG. 7 shows relationships between use states of the wearable terminal 1 assumed by the user and expected detection results of the sensors 406-408.

For example, even if a user tries to measure an amount of exercise using a wearable terminal that is put in a bag, the measurement is not possible with a conventional wearing detection method even if the pulse wave sensor is operating normally. This is because the wearable terminal is judged to be not worn because actually it is not worn by the user and hence the system stops its operation. Although the wearable terminal can be activated forcibly, it requires a manual manipulation by the user.

For another example, if a user picks up a wearable terminal placed on a desk and puts it on his or her arm, switching is made from a worn state to a non-worn state. Therefore, a conventional wearing detection method necessitates activation processing. In contrast, in the embodiment, since the plural sensors are used, control of an operation mode of the devices incorporated in the system can be performed by the operation mode controller 405b, such as activating the pulse wave sensor 406 upon detection of acceleration.

As exemplified below, a variety of operation modes (combinations of operations) are possible:

Mode 1: All functions on.

Mode 2: Screen off, acceleration sensor on (described above)

Mode 3: Screen on (e.g., used as a clock)

Mode 4: Screen off, temperature sensor on

Mode 5: Screen off, sensors on

When the wearable terminal 1 is used, it is not necessarily operate in such a state as to be able to detect a pulse wave. And the wearable terminal 1 may be rendered in a state that does not conform to an intended use of the user who wants its activation (e.g., the above mode 3).

FIG. 8 shows how in a conventional system a detected state variation influences the system. Also in the conventional system the operation of part of the system is stopped to lower the power consumption. However, to enable wearing detection in a state that part of the system is off, the operation of the pulse wave sensor cannot be stopped. In contrast, in the embodiment, the composite wearing detection and the operation mode control enable selection of a sensor(s) that is lower in power consumption than the pulse wave sensor 406.

The wearing detection method according to the embodiment which uses what is called sensor composite information enables wearing detection using non-contact sensors that has not been realized by any of the conventional techniques. Thus, the embodiment makes it possible to realize small information apparatus (wearable apparatus) capable of preventing erroneous detection and satisfying user needs.

### (Supplements)

(1) To solve the problems of the prior art, improvements have been made to enable wearing detection that is free of erroneous detection and operation mode control capable of satisfying user needs by using composite information obtained by a pulse wave sensor and other sensors.

(2) More specifically, non-contact sensors (temperature sensor and acceleration sensor) are used and a judgment “the wearable terminal is worn” is made if a non-contact sensor detects a variation even if the pulse wave sensor does not output a useful value.

(3) A control for selecting an operation mode that determines whether to activate each device is performed according to output values of various sensors.

### (Advantages)

(1) By virtue of composite wearing detection using the contact sensor and other plural sensors, erroneous detection is prevented and the functionality unique to a small information apparatus is enhanced.

(2) The operation mode control enables realization of a small information apparatus capable of satisfying user needs.

(3) The number of times of recovery from a system off state is lowered, whereby the response is made quicker, which means enhanced usability.

(4) The operation mode control enables proper power control of the system, whereby the power consumption of the entire system can be lowered and a small information apparatus capable of long time operation can be realized.

The invention is not limited to the above embodiment, and can be practiced in such a manner that the embodiment is modified in various manners without departing from the spirit and scope of the invention. And various inventive concepts may be conceived by properly combining plural constituent elements disclosed in the embodiment. For example, several ones of the constituent elements of the embodiment may be omitted.

1. A wearable electronic apparatus, comprising:
a non-contact sensor;
a first judgment section which judges whether the electronic apparatus is in a worn/carried state or in a non-worn/carried state on the basis of a detection value of the non-contact sensor; and
a controller which sets an operation mode of the electronic apparatus
into a first mode if the first judgment section judges that the electronic apparatus is in the worn/carried state, and
into to a second mode if the first judgment section judges that the electronic apparatus is in the non-worn/carried state.

2. The apparatus of claim 1, further comprising:
a contact sensor; and
a second judgment section which judges whether the electronic apparatus is in a worn state or in a non-worn state on the basis of a detection value of the contact sensor.

3. The apparatus of claim 2,
wherein the contact sensor is a pulse wave sensor or a pressure sensor.

4. The apparatus of claim 1,
wherein the non-contact sensor is an acceleration sensor or a temperature sensor.

5. The apparatus of claim 2,
wherein the controller activates the contact sensor upon setting into the first mode.

6. The apparatus of claim 1,
wherein, in the second mode, the controller keeps the electronic apparatus in a partial off state.

7. A control method of an electronic apparatus, comprising:
judging whether the electronic apparatus is in a worn/carried state or in a non-worn/carried state on the basis of a detection value of the non-contact sensor; and
setting an operation mode of the electronic apparatus
into a first mode if the first judgment section judges that the electronic apparatus is in the worn/carried state, and
into to a second mode if the first judgment section judges that the electronic apparatus is in the non-worn/carried state.
